(19) United States
(12) Patent Application Publication
(10) Pub. No.: US 2007/0040855 A1
(43) Pub. Date: Feb. 22, 2007

(54) Display control apparatus capable of decreasing the size thereof

(76) Inventor: Fumihiko Kato, Yamagata (JP)

Correspondence Address: YOUNG & THOMPSON, 745 SOUTH 23RD STREET, 2ND FLOOR, ARLINGTON, VA, 22202, US

(21) Appl. No.: 11/503,920

(22) Filed: Aug. 15, 2006

(30) Foreign Application Priority Data
Aug. 16, 2005 (JP) 2005-235781

(51) Int. Cl. G09G 5/10

(52) U.S. Cl. 345/690

(57) ABSTRACT

In a display control apparatus for applying to a display panel first gamma voltages within a first voltage region with reference to two first reference voltages, a gamma voltage generating circuit is adapted to generate second gamma voltages within a second voltage range. A maximum voltage of the second voltage range is lower than a maximum voltage of the first voltage range. At least one digital-to-analog converter is adapted to select one of the second gamma voltages in accordance with a digital video data signal, and at least one output buffer is adapted to step up the selected one of the second gamma voltages into a respective one of the first gamma voltages. The respective one of the first gamma voltages is applied to the display panel.

### BACKGROUND OF THE INVENTION

1. Field of the Invention

The present invention relates to a display control apparatus for a display panel such as a liquid crystal display (LCD) panel, a plasma display panel or an inorganic electroluminescence (EL) display panel.

2. Description of the Related Art

Generally, a prior art display control apparatus is constructed by a gamma voltage generating circuit adapted to generate gamma voltages (multi-gradation voltages) within a voltage range, a digital-to-analog (DA) converter circuit including a plurality of DA converters each adapted to select one of the gamma voltages in accordance with display data, and an output buffer circuit including a plurality of output buffers each adapted to amplify the selected gamma voltages and apply it to a display panel. Each of the output buffers is formed by an operational amplifier, a feedback resistor and a resistor, to form an amplifier (see: JP-11-184444 A). This will be explained later in detail.

Since the output buffer has amplification, the voltage level of the selected gamma voltage can be decreased, so that the operating voltage of the DA converter is decreased. Thus, the breakdown voltage of the DA converter can be decreased so that the DA converter can be decreased in size if the DA converter is manufactured by a conventional manufacturing process for the low breakdown voltage elements, thus decreasing the apparatus in size.

### SUMMARY OF THE INVENTION

In the above-described prior art display control apparatus, however, the amplification of the output buffer depends upon the selected gamma voltage and a voltage required for driving the display panel. Therefore, if the displayed white level or the displayed black level is adjusted, the white level voltage or the black level voltage as well as the resistance values of the output buffer need to be adjusted.

Additionally, since the level shift circuit is required the apparatus would be increased in size.

According to the present invention, in a display control apparatus for applying to a display panel first gamma voltages within a first voltage region with reference to two first reference voltages, a gamma voltage generating circuit is adapted to generate second gamma voltages within a second voltage range. A maximum voltage of the second voltage range is lower than a maximum voltage of the first voltage range. At least one digital-to-analog converter is adapted to select one of the second gamma voltages in accordance with a digital display data signal, and at least one output buffer is adapted to step up the selected one of the second gamma voltages to a respective one of the first gamma voltages. The respective one of the first gamma voltages is applied to the display panel.

### BRIEF DESCRIPTION OF THE DRAWINGS

The present invention will be more clearly understood from the description set forth below, as compared with the prior art, with reference to the accompanying drawings, wherein:

FIG. 1 is a block circuit diagram illustrating a prior art display control apparatus;

FIG. 2 is a detailed circuit diagram of the gamma voltage generating circuit of FIG. 1;

FIG. 3 is a detailed circuit diagram of the DA converter of FIG. 1;

FIG. 4 is a detailed circuit diagram of the output buffer of FIG. 1;

FIG. 5 is a block circuit diagram illustrating a first embodiment of the display control apparatus according to the present invention;

FIG. 6 is a detailed circuit diagram of the gamma voltage generating circuit of FIG. 5;

FIG. 7 is a detailed circuit diagram of the DA converter of FIG. 5;

FIG. 8 is a detailed circuit diagram of the output buffer of FIG. 5;

FIG. 9 is a block circuit diagram illustrating a second embodiment of the display control apparatus according to the present invention;

FIG. 10 is a detailed circuit diagram of the output buffer of FIG. 9;

FIG. 11 is a timing diagram for explaining the operation of the output buffer of FIG. 10;

FIG. 12 is a block circuit diagram illustrating a third embodiment of the display control apparatus according to the present invention;

FIG. 13 is a detailed circuit diagram of the gamma voltage generating circuit of FIG. 12;

FIG. 14 is a detailed circuit diagram of the output buffer of FIG. 12;

FIG. 15 is a timing diagram for explaining the operation of the gamma voltage generating circuit of FIG. 13; and

FIG. 16 is a timing diagram for explaining the operation of the output buffer of FIG. 14.

### DESCRIPTION OF THE PREFERRED EMBODIMENTS

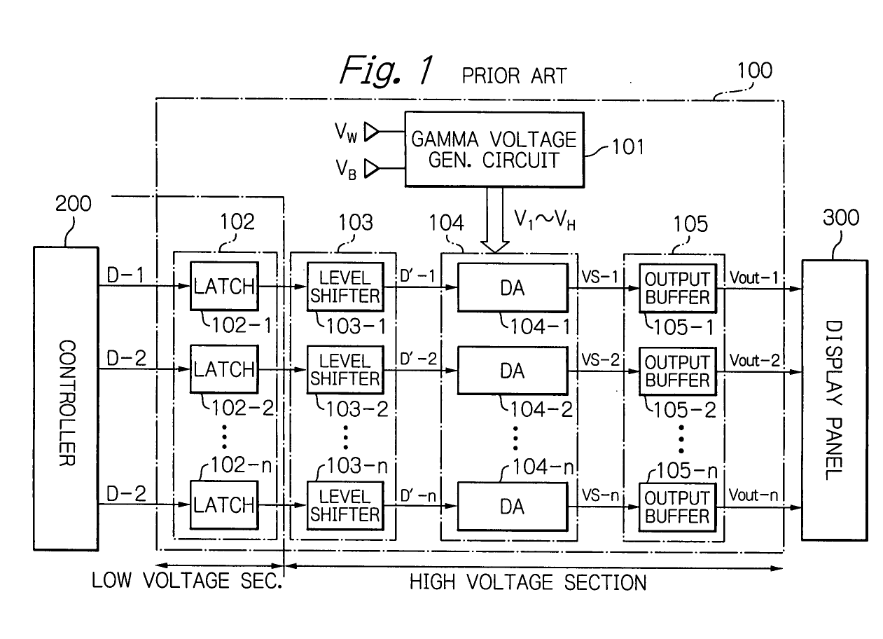

Before the description of the preferred embodiments, a prior art display control apparatus will be explained with reference to FIGS. 1, 2, 3 and 4 (see: JP-11-184444 A).

In FIG. 1, a prior art display control apparatus 100 is such as an LCD control apparatus is provided between a controller 200 and a display panel 300 such as an LCD panel.

The display control apparatus 100 is constructed by a gamma voltage generating circuit 101, a latch circuit 102, a level shift circuit 103, a DA converter circuit 104, and an output buffer circuit 105.

The controller 200 is operated under a low voltage condition, while the display panel 300 is operated under a high voltage condition. Therefore, since the display control apparatus 100 is positioned between the controller 200 and the display panel 300, the display control apparatus 100 is operated under the low voltage condition and the high voltage condition. In more detail, the latch circuit 102 is operated under the low voltage condition while the gamma voltage generating circuit 101, the level shift circuit 103, the DA converter circuit 104 and the output buffer circuit 105 are operated under the high voltage condition.

The gamma voltage generating circuit 101 generates gamma voltages (multi-gradation voltages) V₁ to V_{H} corresponding to a gamma curve of the display panel 300 with reference to a white level voltage V_{W} and a black level voltage V_{B}. This will be explained later in detail.

The latch circuit 102 is formed by latches 102-1, 102-2, . . . , 102-n for receiving video data signals D-1, D-2, . . . , D-n from the controller 200.

The level shift circuit 103 is formed by level shifters 103-1, 103-2, . . . , 103-n for shifting the video data signals D-1, D-2, . . . , D-n under the low voltage condition to generate video data signals D′-1, D′-2, . . . , D′-n under the high voltage condition.

The DA converter circuit 104 is formed by DA converters 104-1, 104-2, . . . , 104-n for performing DA conversions upon the level-shifted video data signals D′-1, D′-2, . . . , D′-n using the gamma voltages V₁ to V_{H} to generate analog voltages VS-1, VS-2, . . . , VS-n. This will be explained later in detail.

The output buffer circuit 105 is formed by output buffers 105-1, 105-2, . . . , 105-n for amplifying the analog voltages VS-1, VS-2, . . . , VS-n to generate video output voltages Vₒᵤₜ-1, Vₒᵤₜ-2, . . . , Vₒᵤₜ-n which are applied to the display panel 300 such as data lines thereof. This will be explained later in detail.

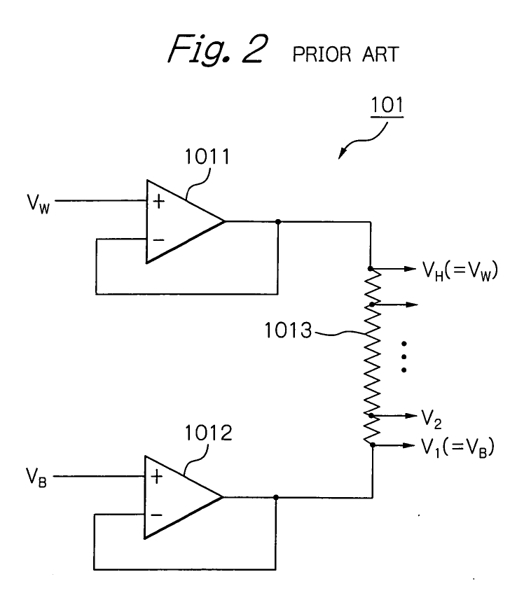

As illustrated in FIG. 2, the gamma voltage generating circuit 101 of FIG. 1 is formed by an operational amplifier 1011 serving as a voltage follower 1011 for performing an impedance conversion upon the white level voltage V_{W}, an operational amplifier 1012 serving as a voltage follower for performing an impedance conversion upon the black level voltage V_{B}, and a voltage divider 1013 formed by resistors connected in series whose ends are connected to the outputs of voltage followers 1011 and 1012. The resistance values of the resistors of the voltage divider are adapted for the gamma curve of the display panel 300 to generate gamma voltages V₁, V₂, . . . , V_{H} within a range from V_{B} to V_{W}.

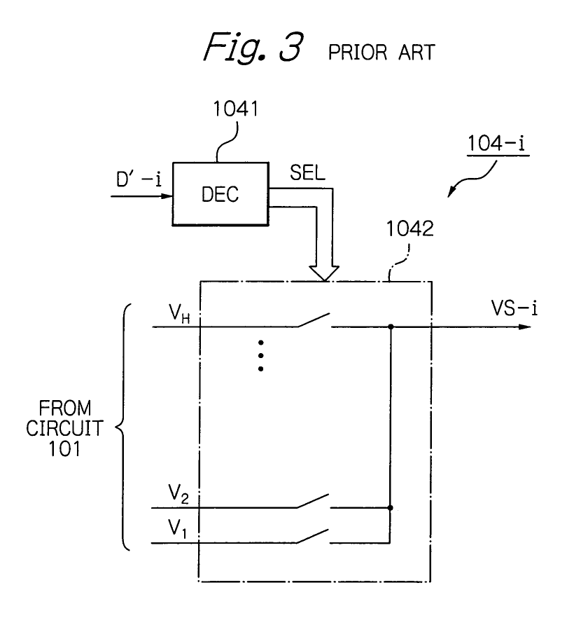

As illustrated in FIG. 3, the DA converter 104-i of FIG. 1 is formed by a decoder 1041 for decoding the level-shifted video data signal D′-i to generate a selection signal SEL, and a selector 1042 for selecting one of the gamma voltages V₁ to V_{H} in accordance with the selection signal SEL to generate the analog voltage VS-i. In this case, since the gamma voltages V₁ to V_{H} are of a large amplitude, the switching elements of the DA converter 104-i need to be high breakdown voltage elements, which would increase the size thereof.

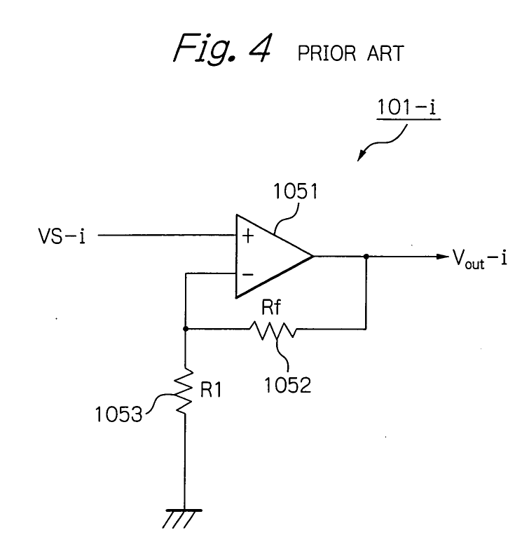

As illustrated in FIG. 4, the output buffer 105-i of FIG. 1 is formed by an operational amplifier 1051, a feedback resistor 1052 and a resistor 1053, thus forming an amplifier having an amplification β defined by
β=1+R_{f}/R₁

where R_{f} is a resistance value of the feedback resistor 1052; and

R1 is a resistance value of the resistor 1053.

Since the output buffer 105-i has the amplification β, the voltage level of the analog voltage VS-i can be decreased by 1/β, so that the operating voltage of the DA converter 104-i is decreased. Thus, the breakdown voltage of the DA converter 104-i can be decreased so that the DA converter 104-i can be decreased in size if the DA converter 104-i is manufactured by a conventional manufacturing process for the low breakdown voltage elements, thus decreasing the apparatus in size.

In the output buffer 105-i, however, the amplification β depends upon the analog voltage VS-i and a voltage required for driving the display panel 300. Therefore, if the displayed white level or the displayed black level is adjusted, the white level voltage V_{W} or the black level voltage V_{B} as well as the resistance values Rf and R1 need to be adjusted. In the case of adjusting the resistance values Rf and R1, various resistors and switching circuits therefor need to be provided in advance, which would complicate the circuit configuration. Note that, the finer the adjustment of the resistance values Rf and R1, the larger the number of resistors and switching circuits. Further, in the case of only one of the displayed white level and the displayed black level being adjusted, an offset adjustment would be required, which would further complicate the circuit configuration.

Still, since the level shift circuit 103 is required between the latch circuit 102 and the DA converter circuit 104, the apparatus would be increased in size.

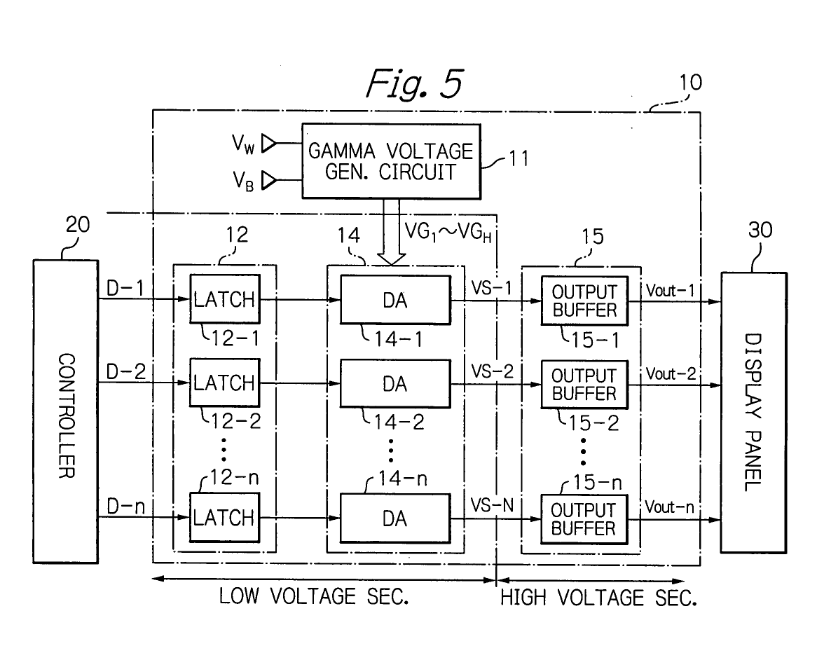

In FIG. 5, which illustrates a first embodiment of the display control apparatus according to the present invention, a display control apparatus 10 such as an LCD control apparatus is provided between a controller 20 and a display panel 30 such as an LCD panel. Note that the controller 20 and the display panel 30 correspond to the controller 200 and the display panel 300, respectively, of FIG. 1.

The display control apparatus 10 is constructed by a gamma voltage generating circuit 11, a latch circuit 12, a DA converter circuit 14, and an output buffer circuit 15. Since the level shift circuit 103 of FIG. 1 is not provided, the apparatus 10 can be decreased in size. Also, the latch circuit 12 and the DA converter circuit 14 are operated under the low voltage condition while the gamma voltage generating circuit 11 and the output buffer circuit 15 are operated under the high voltage condition.

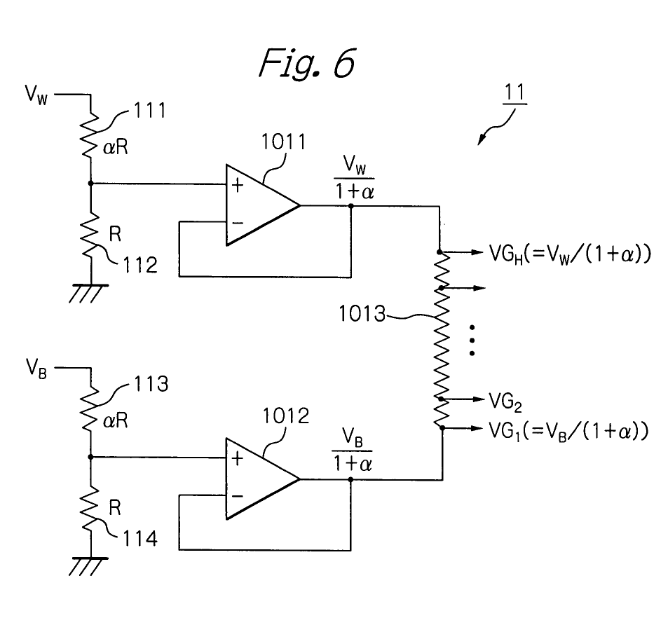

As illustrated in FIG. 6, the gamma voltage generating circuit 11 of FIG. 5 includes resistors 111, 112, 113 and 114 in addition to the elements of the gamma voltage generating circuit 101 of FIG. 2. The resistors 111 and 112 divide the white level voltage V_{W} to generate
V_{W}/(1+α)

where β is a resistance ratio of the resistor 111 to the resistor 112. Similarly, the resistors 113 and 114 divide the black level voltage V_{B} to generate
V_{B}/(1+α)

where α is a resistance ratio of the resistor 113 to the resistor 114. Therefore, the voltage divider 1013 generates gamma voltages VG₁, VG₂, . . . , VG_{H} with reference to V_{B}/(1+α) to V_{W}/(1+α).

The gamma voltages VG₁, VG₂, . . . , VG_{H} can be processed within a circuit which can be manufactured by a conventional process for manufacturing low breakdown voltage elements.

Also, in FIG. 6, since the resistance ratio α is accurately realized by the relative sizes of the resistors 111, 112, 113 and 114, the gamma voltages VG₁, VG₂, . . . , VG_{H} can be accurately determined by the resistance ratio α.

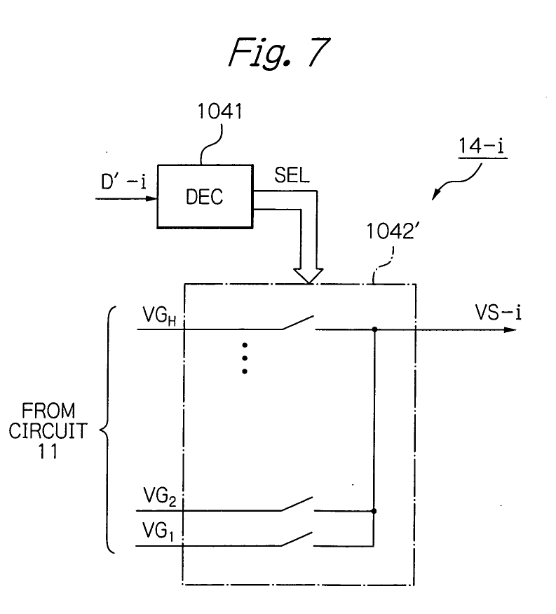

As illustrated in FIG. 7, the DA converter 14-i of FIG. 5 includes a selector 1042′ instead of the selector 1042 of FIG. 3. The selector 1042′ selects one of the gamma voltages VG₁ to VG_{H} in accordance with the selection signal SEL to generate the analog voltage VS-i. In this case, since the gamma voltages VG₁ to VG_{H} are of a small amplitude, the switching elements of the DA converter 14-i need to be low breakdown voltage elements, which would decrease the size thereof.

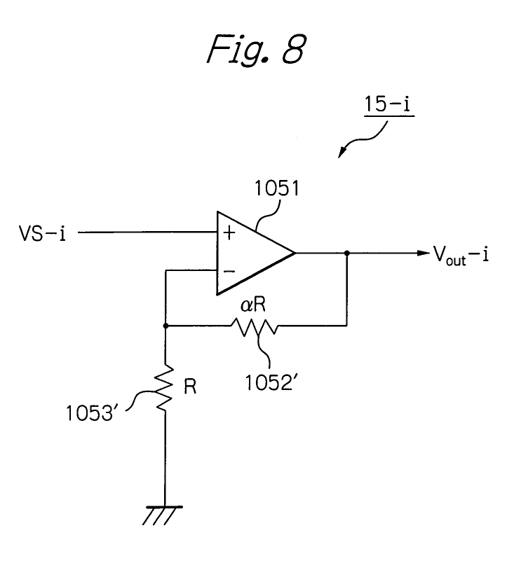

As illustrated in FIG. 8, the output buffer 15-i of FIG. 5 includes a feedback resistor 1052′ and a resistor 1053′ instead of the feedback resistor 1052 and the resistor 1053 of FIG. 4. That is, the resistance ratio of the feedback resistor 1052′ to the resistor 1053′ is set to be α. Therefore, the output buffer 15-i forms an amplifier having an amplification (1+α).

As stated above, the gamma voltage generating circuit 11 generates the gamma voltages VG₁ to VG_{H} which are 1/(1+α) times the gamma voltages VG₁ to VG_{H}. Therefore, if the DA converter 12-i selects the gamma voltage VG_{X}, then
VS-i=VG_{X}
=V_{X}/(1+α)

On the other hand, since the output buffer 12-i generates the video output signal Vₒᵤₜ-i by amplifying the gamma voltage VG_{X} by the amplification (1+α), i.e.,
Vₒᵤₜ-i=VG_{X}·(1+α)
=V_{X}

Thus, the video output signal Vₒᵤₜ-i applied to the display panel 30 is the same as the gamma voltage V_{X} which should be originally applied to the display panel 30.

Also, in FIG. 8, since the resistance ratio α is accurately realized by the relative sizes of the resistors 1052′ and 1053′, the amplification (1+α) of the output buffer 15-i can be accurately determined by the resistance ratio α.

Thus, in the above-described first embodiment, the gamma voltage generating circuit 11 generates the gamma voltages VG₁ to VG_{H} with reference to V_{W}/(1+α) and V_{B}/(1+α) by adjusting the relative sizes of the resistors 111, 112, 113 and 114. The gamma voltages VG₁ to VG_{H} are so low that they are processed in elements which can be manufactured by a conventional process for manufacturing low breakdown voltage elements, and are 1/(1+α) of the voltage V₁ to V_{H} which should be originally applied to the display panel 20. One of the gamma voltages VG₁ to VG_{H} is selected by the DA converter 12-i and is amplified with the amplification (1+α) of the output buffer 15-i to obtain the video output signal Vₒᵤₜ-I the same as the originally-applied to the display panel 20.

In the above-described first embodiment, if the displayed white level or the displayed black level is adjusted, only the white level voltage V_{W} or the black level voltage V_{B} is adjusted. Therefore, no resistors and switching circuits for adjusting the displayed white level or the displayed black level are necessary in the output buffer 15-i, which would simplify the circuit configuration.

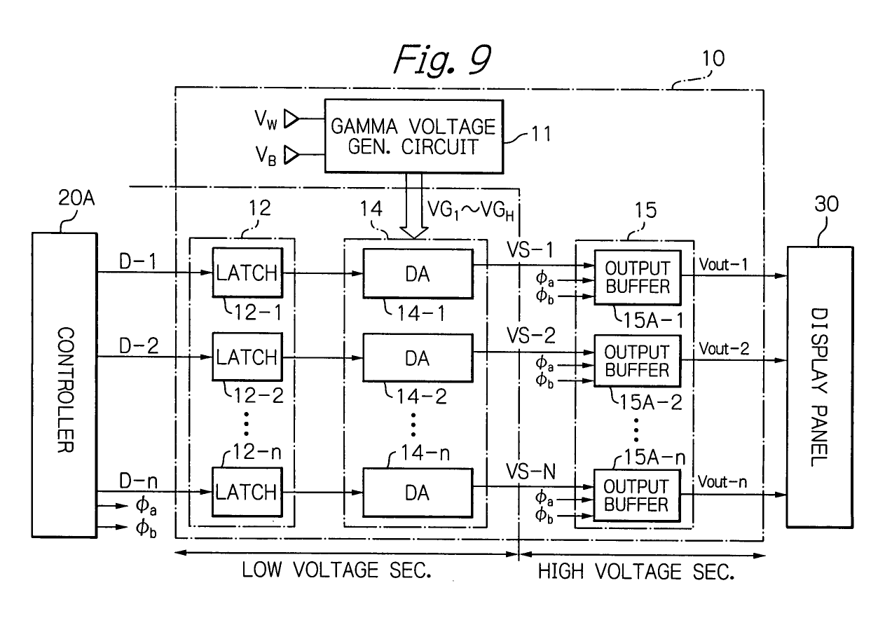

In FIG. 9, which illustrates a second embodiment of the display control apparatus according to the present invention, the controller 20 of FIG. 5 is replaced by a controller 20A, and the output buffer 15-i(i=1, 2, . . . , n) of FIG. 5 is replaced by an output buffer 15A-i(i=1, 2, . . . , n). Timing signals φₐ and φ_{b} opposite in phase to each other are supplied from the controller 20A to the output buffer 15-i.

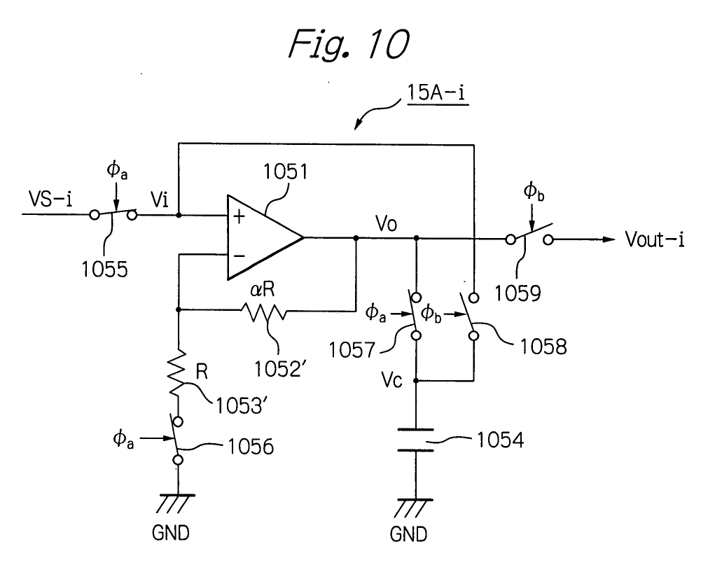

As illustrated in FIG. 10, the output buffer 15A-i includes a capacitor 1054 and switches 1055 to 1059 in addition to the elements of the output buffer 15-i of FIG. 8. The switch 1055 is connected to the non-inverted input of the operational amplifier 1051; the switch 1056 is connected between the resistor 1053′ and the ground terminal GND; the switch 1057 is connected between the output of the operational amplifier 1051 and the capacitor 1054; the switch 1058 is connected between the capacitor 1054 and the input of the operational amplifier 1051, and the switch 1059 is connected between the output of the operational amplifier 1051 and the display panel 30. The switches 1055, 1056 and 1057 are turned ON and OFF by the timing signal φₐ, while switches 1058 and 1059 are turned ON and OFF by the timing signal φ_{b}. That is, when the timing signals φₐ and φ_{b} are high and low, respectively, the switches 1055, 1056 and 1057 are turned ON and the switches 1058 and 1059 are turned OFF, while, when the timing signals φₐ and φ_{b} are low and high, respectively, the switches 1058 and 1059 are turned ON and the switches 1055, 1056 and 1057 are turned OFF. Note that Vᵢ and V₀ designate voltages at a non-inverted input and an output of the operational amplifier 1051.

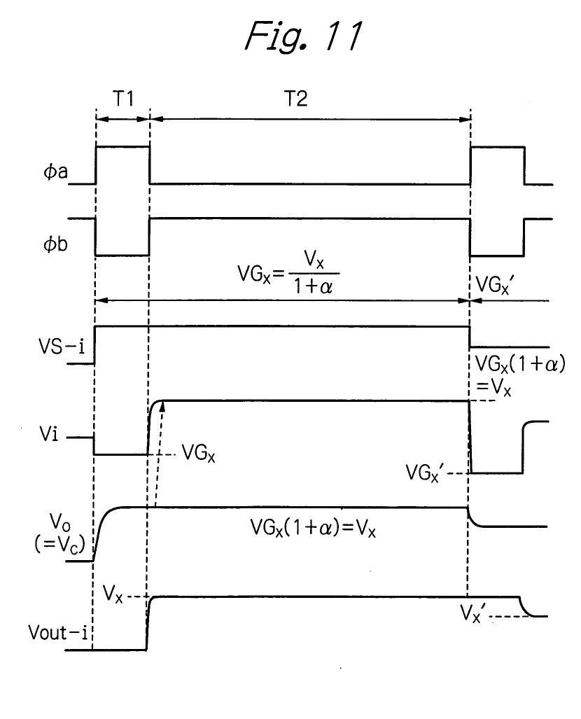

The operation of the output buffer 15A-i of FIG. 10 is explained next with reference to FIG. 11.

In a charging time period T1 where the timing signals φₐ and φ_{b} are high and low, respectively, the switches 1055, 1056 and 1057 are turned ON and the switches 1058 and 1059 are turned OFF. As a result, the analog voltage VS-i which is in this case VG_{X}=V_{X}/(1+α) is supplied via the turned-ON switch 1055 to a non-inverted input of the operational amplifier 1051, so that the input voltage Vᵢ is given by

$$\begin{matrix}{V}_{i} = {VG}_{X} \\ = {V}_{X} / ( 1 + α ) .\end{matrix}$$

Also, since the switch 1056 is turned ON, the operational amplifier 1051 with the resistors 1052′ and 1053′ serves as an amplifier having the amplification of (1+α), so that the output voltage V₀ is given by

$$\begin{matrix}{V}_{0} = {V}_{i} \cdot ( 1 + α ) \\ = {VG}_{X} \cdot ( 1 + α ) \\ = {V}_{X} / ( 1 + α ) \cdot ( 1 + α ) \\ = {V}_{X} .\end{matrix}$$

Thus, since the switch 1057 is turned ON, the capacitor 1054 is charged by the voltage V₀ (=V_{X}), so that the voltage V₀ at the capacitor 1054 is also V₀ (=V_{X}). In this case, since the switches 1058 and 1059 are turned OFF, the voltages V₀ and V_{C} are isolated from the input voltage Vᵢ and the video output signal Vₒᵤₜ-i.

Next, in a holding time period T2 where the timing signals φₐ and φ_{b} are low and high, respectively, the switches 1058 and 1059 are turned ON and the switches 1055, 1056 and 1057 are turned OFF. As a result, since the switch 1058 is turned ON, the input voltage Vᵢ becomes the voltage V_{C} at the capacitor 1054, so that the capacitor 1054 is moved from a charging state to a holding state. That is,

$$\begin{matrix}{V}_{i} = {V}_{C} \\ = {VG}_{X} ( 1 + α ) \\ = {V}_{X}\end{matrix}$$

In this case, since the input impedance of the operational amplifier 1051 is very large, the capacitor 1054 is hardly discharged, so that the voltage V_{C} remains at about the same level. Thus, the capacitor 1054 can serve as an analog memory which carries out a storing operation during the charging time period T1 and carries out an outputting operation during the holding time period T2.

On the other hand, since the switch 1056 is turned OFF, the operational amplifier 1051 serves as a voltage follower, so that the output voltage V₀ is same as the input voltage Vᵢ, i.e., V₀=Vᵢ. Also, since the switch 1059 is turned ON, the video output signal Vₒᵤₜ-i is given by

$$\begin{matrix}{V}_{out} - i = {V}_{0} \\ = {V}_{i} \\ = {V}_{X}\end{matrix}$$

Note that the video output signal Vₒᵤₜ-i during the time period T1 remains at the level during the time period T2 due to the line-to-line capacitance, since the switch 1059 is turned OFF.

Thus, in the second embodiment, in the same way as in the first embodiment, the output buffer 15A-i amplifies the compressed gamma voltages VG_{X} with the amplification of (1+α) to generate the original gamma voltages V_{X} (=VGₓ·(1+α)). In addition, during the holding time period T2, since the switch 1056 is turned OFF, the output of the operational amplifier 1051 is shunted from the ground terminal GND, so that no current flows through the resistors 1052′ and 1053′, which would decrease the power consumption.

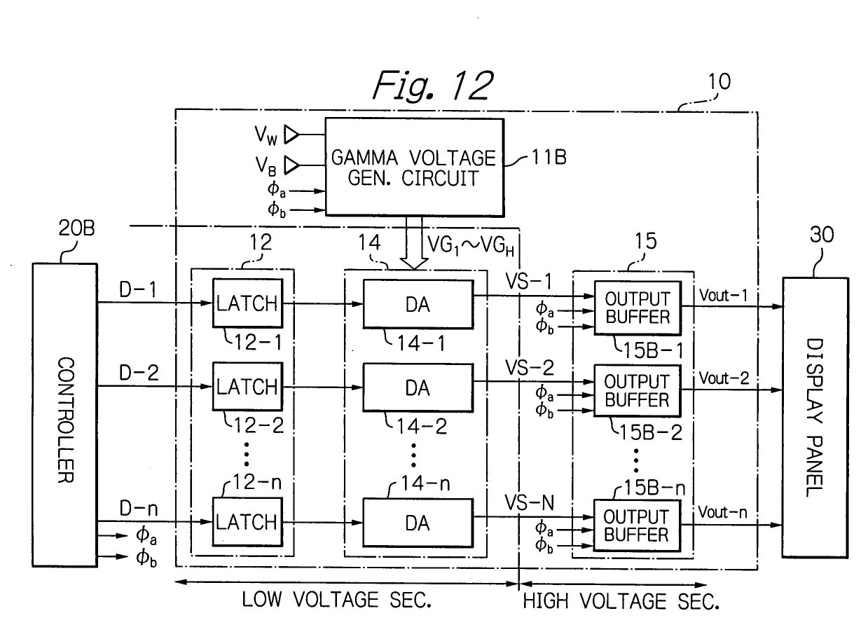

In FIG. 12, which illustrates a third embodiment of the display control apparatus according to the present invention, the controller 20 of FIG. 5 is replaced by a controller 20B, the gamma voltage generating circuit 11 of FIG. 5 is replaced by a gamma voltage generating circuit 11B, and the output buffer 15-i(i=1, 2, . . . , n) of FIG. 5 is replaced by an output buffer 15B-i(i=1, 2, . . . , n). Timing signals φₐ and φ_{b} opposite in phase to each other are supplied from the controller 20B to the gamma voltage generating circuit 11B and the output buffer 15B-i.

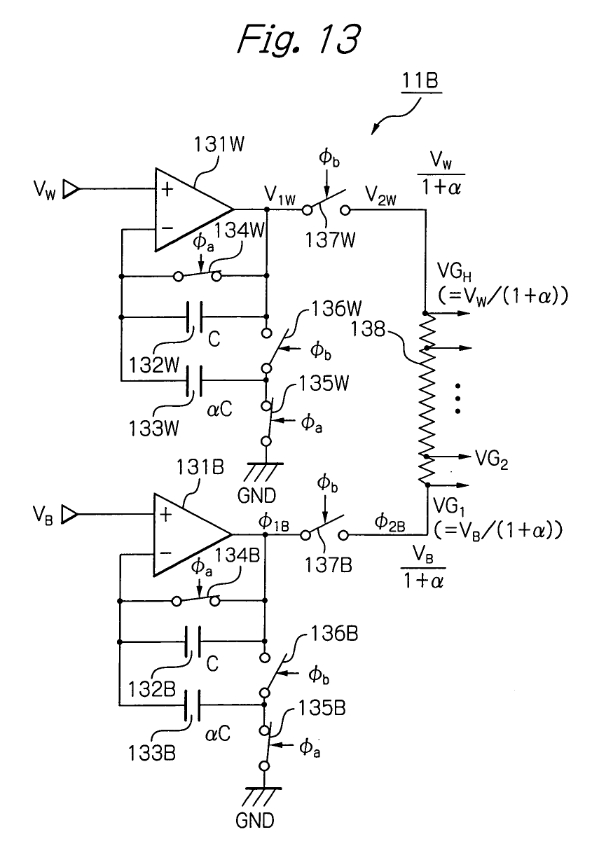

As illustrated in FIG. 13, the gamma voltage generating circuit 11B is formed by an operational amplifier 131W, capacitors 132W and 133W, and switches 134W, 135W, 136W and 137W for the white level voltage V_{W}, an operational amplifier 131B, capacitors 132B and 133B, and switches 134B, 135B, 136B and 137B for the black level voltage V_{B}, and a voltage divider 138 formed by resistors connected in series whose ends are connected to the switches 137W and 137B. The resistance values of the resistors of the voltage divider 138 are adapted for the gamma curve of the display panel 30 to generate gamma voltages VG₁, VG₂, . . . , VG_{H} within a range from V_{B}/(1+α) to V_{W}/(1+α).

The white level voltage V_{W} is applied to the non-inverted input of the operational amplifier 131W. The output of the operational amplifier 131W is connected via the capacitor 132W and the switch 134W to the inverted input of the operational amplifier 131W. In this case, the switch 134W is connected in parallel to the capacitor 132W to discharge the capacitor 132W. Also, the capacitor 133W is connected via the switch 135W to the ground terminal GND. In this case, the switch 135W is used for charging the capacitor 133W. Further, the switch 136W is used for connecting the capacitor 132W and 133W in parallel to each other. The output of the operational amplifier 131W is connected to the voltage divider 138. The capacitance ratio of the capacitor 132W to the capacitor 133W is 1/α.

The switches 134W and 135W are turned ON and OFF by the timing signal φₐ, and the switches 136W and 137W are turned ON and OFF by the timing signal φ_{b}.

The black level voltage V_{B} is applied to the non-inverted input of the operational amplifier 131B. The output of the operational amplifier 131B is connected via the capacitor 132B and the switch 134B to the inverted input of the operational amplifier 131B. In this case, the switch 134B is connected in parallel to the capacitor 132B to discharge the capacitor 132B. Also, the capacitor 133B is connected via the switch 135B to the ground terminal GND. In this case, the switch 135B is used for charging the capacitor 133B. Further, the switch 136B is used for connecting the capacitor 132B and 133B in parallel to each other. The output of the operational amplifier 131B is connected to the voltage divider 138. The capacitance ratio of the capacitor 132B to the capacitor 133B is 1/α.

The switches 134B and 135B are turned ON and OFF by the timing signal φₐ, and the switches 136B and 137B are turned ON and OFF by the timing signal φ_{b}.

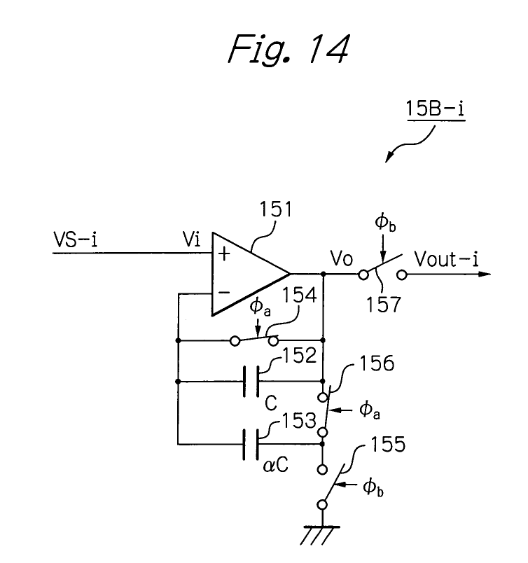

As illustrated in FIG. 14, the output buffer 15B-i is formed by an operational amplifier 151, capacitor 152 and 153, and switches 154, 155, 156 and 157.

The analog voltage VS-i is applied to the non-inverted input of the operational amplifier 151. The output of the operational amplifier 151 is connected via the capacitor 152 and the switch 154 to the inverted input of the operational amplifier 151. In this case, the switch 154 is connected in parallel to the capacitor 152 to discharge the capacitor 152. Also, the capacitor 153 is connected via the switch 155 to the ground terminal GND. In this case, the switch 155 is used for charging the capacitor 153. Further, the switch 156 is used for connecting the capacitors 152 and 153 in parallel to each other. The output of the operational amplifier 151 is connected via the switch 157 to the display panel 20. The capacitance ratio of the capacitor 152 to the capacitor 153 is 1/α.

The switches 154 and 155 are turned ON and OFF by the timing signal φₐ and the switches 156 and 157 are turned ON and OFF by the timing signal φ_{b}.

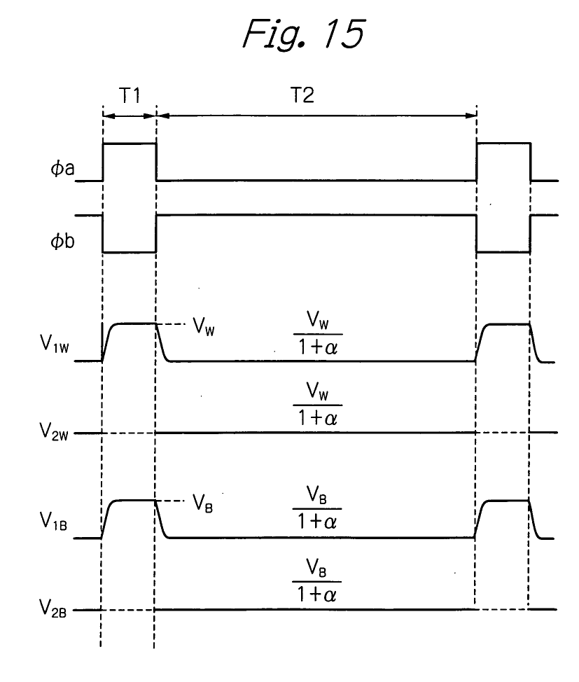

The operation of the gamma voltage generating circuit 11B of FIG. 13 is explained next with reference to FIG. 15.

In a time period T1 where the timing signals φₐ and φ_{b} are high and low, respectively, the switches 134W and 135W are turned ON and the switches 136W and 137W are turned OFF. As a result, the output of the operational amplifier 131W is connected directly to the inverted input thereof, and the capacitor 133W is connected between the output of the operational amplifier 131W and the ground terminal GND. Therefore, since the capacitor 132W is short-circuited by the switch 134W, the operational amplifier 131W is operated as a voltage buffer. Therefore, the output voltage V_{1W} of the operational amplifier 131W is the white level voltage V_{W}, i.e.,
V_{1W}=V_{W}

In this case, the capacitor 133W is charged at Q1 represented by
Q1=αC·V_{W}

where αC is the capacitance of the capacitor 133W.

In this case, since the switch 137W is turned OFF, the voltage V_{1W} is isolated from the voltage divider 138.

Next, in a time period T2 where the timing signals φₐ and φ_{b} are low and high, respectively, the switches 136W and 137W are turned ON and the switches 134W and 135W are turned OFF. As a result, the capacitors 132W and 133W are connected in parallel between the non-inverted input and output of the operational amplifier 131W. In this case, since the voltage between the inverted input voltage V_{W} and the output voltage V_{1W} of the operational amplifier 131W is applied to a combined capacitance of the capacitors 132W and 133W, the capacitors 132W and 133W are charged at Q2 by
Q2=(V_{W}−V_{1W})·(C+αC)

where C and αC are the capacitances of the capacitors 132W and 133W, respectively. Here, Q1=Q2, then
V_{1W}=V_{W}/(1+α)

Also, since the switch 137W is turned ON, the voltage V_{2W} is also given by
V_{2W}=V_{W}/(1+α)

The above-described operation for the white level voltage V_{W} is true for the black level voltage V_{B}. Therefore, during the discharging period T2,
V_{1B}=V_{2B}=V_{B}/(1+α)

Thus, during the time period T2, the voltage V_{2W} (=V_{W}/(1+α)) and the voltage V_{2B}(=V_{B}/(1+α)) are applied to the voltage divider 138. As a result, gamma voltages VG₁ to VG_{H} are generated with reference to V_{W}/(1+α) and V_{B}/(1+α) by adjusting the capacitance ratio 11a of the capacitor 132W (132B) to the capacitor 133W (133B). In this case, if a current hardly flows from the gamma voltage generating circuit 11B to the DA converter 14-i, since the switch 137W (137B) is turned OFF during the time period T1, the output voltage V_{2W}(V_{2B}) remains at the same level as that during the discharging period T2, as indicated by a dotted line.

In the gamma voltage generating circuit 11B, although currents only flow to charge the capacitors 132W and 133W (132B and 133B), since the operational amplifier 131W (131B) is shunted from the voltage divider 138 as well as the ground terminal GND during the time period T2, the power consumption can be decreased.

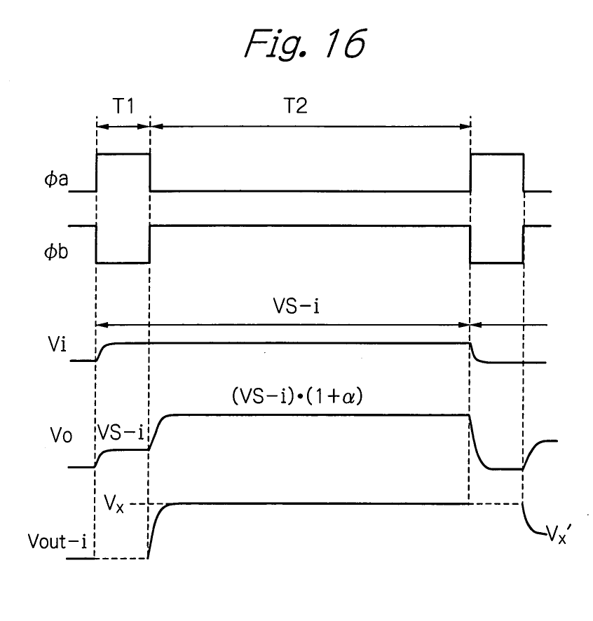

The operation of the output buffer 15B-i of FIG. 14 is explained next with reference to FIG. 16.

In a charging time period T1 where the timing signals φₐ and φ_{b} are high and low, respectively, the switches 154 and 156 are turned ON and the switches 155 and 157 are turned OFF. As a result, since the capacitors 152 and 153 are short-circuited by the turned-ON switches 154 and 156 to discharge them, the operational amplifier 151 serves as a voltage follower. Therefore, the analog voltage VS-i which is in this case VG_{X}=V_{X}/(1+α) is the same as that of the output voltage V₀ of the operational amplifier 151, i.e.,

$$\begin{matrix}{V}_{0} = {VG}_{X} \\ = {V}_{X} / ( 1 + α ) .\end{matrix}$$

In this case, since the switch 157 is turned OFF, the voltage V₀ is isolated from the video output signal Vₒᵤₜ-i.

Next, in a holding time period T2 where the timing signals φₐ and φ_{b} are low and high, respectively, the switches 155 and 157 are turned ON and the switches 154 and 156 are turned OFF. As a result, the capacitors 152 and 153 are connected in series between the output of the operational amplifier 151 and the ground terminal GND, and also, the connection node between the capacitors 152 and 153 is connected to the inverted input of the operational amplifier 151. In this case, since the input voltage Vᵢ is applied to this connection node by the hypothetical short-circuit between the two inputs of the operational amplifier 151, the capacitor 152 is charged at Q3 by
Q3=C·(V₀−Vᵢ)

where C is the capacitance of the capacitor 152. Also, the capacitor 153 is charged at Q4 by

$$Q 4 = α C \cdot {V}_{i}$$

$$Here , \\ Q 3 = Q 4 , \\ then$$

$$\begin{matrix}{V}_{0} = ( 1 + α ) {V}_{i} \\ = ( 1 + α ) \cdot {V}_{X} / ( 1 + α ) \\ = {V}_{X}\end{matrix}$$

Also, since the switch 157 is turned ON, the video output signal Vₒᵤₜ-i is given by

$$\begin{matrix}{V}_{out} - i = {V}_{0} \\ = {V}_{X}\end{matrix}$$

Note that the video output signal Vₒᵤₜ-i during the time period T1 remains at the level during the time period T2 due to the line-to-line capacitance, since the switch 157 is turned OFF.

Thus, in the third embodiment, in the same way as in the second embodiment, the gamma voltage generating circuit 11B generates the compressed gamma voltage VG₁ and the output buffer 15B-i amplifies the compressed gamma voltage VG_{X} with the amplification of (1+α) to generate the original gamma voltage V_{X}(=VG_{X}·(1+α)).

In any of the above-described embodiments, since the DA converter 14-i is subject to the compressed gamma voltage V_{X}/(1+α), the DA converter 14-i can be manufactured by a process for manufacturing low breakdown voltage elements, which would decrease the manufacturing cost. Also, when one of the displayed white level or the displayed black level is adjusted, only the white voltage V_{W} or the black voltage V_{B} is adjusted. Therefore, no adjustment of individual gamma voltages is necessary, which would simplify the circuit configuration.

In the above-described third embodiment, the output buffer 15B-i requires no resistor elements such as the resistors 1052′ and 1053′ in the first and second embodiments, which would decrease the power consumption. In the first and second embodiments, note that, if the video output signal Vₒᵤₜ-i is 5 μA, a current of 5 μA flows the resistors 1052′ and 1053′, which would increase the power consumption.

1. A display control apparatus for applying to a display panel first gamma voltages within a first voltage region with reference to two first reference voltages, comprising:
a gamma voltage generating circuit adapted to generate second gamma voltages within a second voltage range, a maximum voltage of said second voltage range being lower than a maximum voltage of said first voltage range;
at least one digital-to-analog converter adapted to select one of said second gamma voltages in accordance with a digital video data signal; and
at least one output buffer adapted to step up the selected one of said second gamma voltages into a respective one of said first gamma voltages, the respective one of said first gamma voltages being applied to said display panel.

2. The display control apparatus as set forth in claim 1, wherein said gamma voltage generating circuit comprises:
a voltage stepping-down circuit adapted to receive said first maximum to step-down said two first reference voltages to generate two second reference voltages for said second voltage region; and
a voltage divider adapted to generate said second gamma voltages in accordance with said two second reference voltages.

3. The display control apparatus as set forth in claim 1, wherein said voltage stepping-down circuit comprises a voltage divider formed by first and second resistors whose resistance ratio is 1:α, so that said two second reference voltages are 1/(1+α)-times said two first reference voltages, respectively.

4. The display control apparatus as set forth in claim 1, wherein said gamma voltage generating circuit comprises:
a first operational amplifier having a non-inverted input for receiving one of said two first reference voltages;
a first capacitor connected between an output and an inverted input of said first operational amplifier;
a first switch connected between the output and the inverted input of said first operational amplifier and adapted to discharge said first capacitor;
second and third switches; and
a second capacitor having an end connected to the inverted input of said first operational amplifier and another end connected via said second switch to a ground terminal and via said third switch to the output of said first operational amplifier,
said second switch being adapted to charge said second capacitor to one of said two first reference voltages,
said third switch being adapted to connect said first and second capacitors in parallel with each other,
a capacitance ratio of said first capacitor to said second capacitor being 1:α,
turning ON of said first and second switches and turning ON of said third switch being time-divisionally carried out.

5. The display control apparatus as set forth in claim 1, wherein said output buffer comprises:
a second operational amplifier having a non-inverted input for receiving the selected one of said second gamma voltages;
a feedback resistor connected between an output and an inverted input of said second operational amplifier; and
a resistor connected between the inverted input of said second operational amplifier and a ground terminal, a resistance ratio of said resistor to said feedback resistor being 1:α.

6. The display control apparatus as set forth in claim 5, wherein said output buffer further comprises:
an analog memory;
a selection circuit for selectively supplying the selected one of said second gamma voltages or an analog voltage of said analog memory to the non-inverted input of said second operational amplifier;
a fourth switch connected between the output of said second operational amplifier and said analog memory; and
a fifth switch connected between said resistor and said ground terminal and adapted to switch an amplification of said output buffer between 1 and 1+α,
said analog memory storing (1+α) times the selected one of said second gamma voltages from the output of said second operational amplifier via said fourth switch when said fifth switch is turned ON, so that the amplification of said output buffer is 1+α,
said analog memory transmitting said stored analog voltage to the non-inverted input of said second operational amplifier through said selection circuit when said fifth switch is turned OFF, so that the amplification of said output buffer is 1.

7. The display control apparatus as set forth in claim 6, wherein said analog memory comprises a third capacitor.

8. The display control apparatus as set forth in claim 1, wherein said output buffer comprises:
a second operational amplifier having a non-inverted for receiving the selected one of said second gamma voltages;
a third capacitor connected between an output and an inverted input of said second operational amplifier;
sixth, seventh and eighth switches;
a fourth capacitor having an end connected to the inverted input of said second operational amplifier and another end connected via said sixth switch to the output of said second operational amplifier and via said eighth switch to a ground terminal;
said sixth switch being adapted to connect said third and fourth capacitors in parallel with each other; and
said seventh switch being adapted to discharge said third and fourth capacitors,
a capacitance ratio of said first capacitor to said second capacitor being 1:α,
turning ON of said sixth and seventh switches and turning ON of said eighth switch being time-divisionally carried out.

9. The display control apparatus as set forth in claim 1, wherein said first reference voltage is a white level voltage, and said second reference voltage is a black level voltage.

10. The display control apparatus as set forth in claim 1, further comprising at least one data latch directly connected to said digital-to-analog converter and adapted to supply said digital video data signal to said digital-to-analog converter.

11. A display control method for applying to a display panel first gamma voltages within a first voltage region with reference to two first reference voltages, comprising:
stepping down said two first reference voltages to two second reference voltages, respectively, for second gamma voltages within a second voltage region, a maximum voltage of said second voltage region being lower than a maximum voltage of said first voltage region;
generating said second gamma voltages with reference to said two second reference voltages;
performing a digital-to-analog conversion upon a digital video data signal by selecting one of said second gamma voltages in accordance with said digital video data signal; and
stepping up the selected one of said second gamma voltages to a respective one of said first gamma voltages, the respective one of said first gamma voltage being applied to said display panel.

12. The display control method as set forth in claim 11, wherein said stepping-down comprises dividing said two first reference voltages by (1+α) to generate said two second reference voltages,
said stepping-up comprising multiplying the selected one of said second gamma voltages by (1+α) to generate the respective one of said first gamma voltages.

13. The display control method as set forth in claim 11, wherein said stepping-down comprises:
discharging a first capacitor;
charging a second capacitor using one of said first reference voltages; and
connecting said first and second capacitors in parallel with each other to generate one of said second reference voltages.

14. The display control method as set forth in claim 11, wherein said stepping-up comprises:
amplifying the selected one of said second gamma voltages by (1+α);
storing the amplified selected one of said second gamma voltage in a third capacitor; and
transmitting a stored voltage in said third capacitor as the respective one of said first gamma voltages.

15. The display control method as set forth in claim 11, wherein said stepping-down comprises:
connecting third and fourth capacitors in parallel with each other;
discharging said third and fourth capacitors connected in parallel with each other;
connecting said third and fourth capacitors in series with each other; and
supplying the selected one of said second gamma voltages to a node between said third and fourth capacitors connected in series with each other, so that said third and fourth capacitors generate the respective one of said first gamma voltages.
